(19) United States
(12) Patent Application Publication
(10) Pub. No.: US 2017/0039264 A1
(43) Pub. Date: Feb. 9, 2017

(54) AREA MODELING BY GEOGRAPHIC PHOTO LABEL ANALYSIS

(71) Applicant: Google Inc., Mountain View, CA (US)

(72) Inventors: Brian Edmond Brewington, Fort Collins, CO (US); Kirk Johnson, Boulder, CO (US); Georgi Tsankov, Boulder, CO (US)

(21) Appl. No.: 14/817,564

(22) Filed: Aug. 4, 2015

(51) Int. Cl. G06F 17/30

(52) U.S. Cl. CPC G06F 17/30598; G06F 17/30268; G06F 17/30241

(57) ABSTRACT

The technology relates to determining a description of a geographic area. One or more computing devices may receive a set of images, wherein each image includes data associated with geolocation data and labels describing the contents of the images. Each image in the set of images may be assigned to one or more buckets corresponding to a geographic area based at least in part on the geolocation information. Based on an inquiry identifying one or more geolocations, a set of one or more buckets that are associated with geographic areas that cover the one or more geolocations may be determined. Labels associated with the images assigned to the set of buckets may be identified and a description of the one or more geolocations may be generated. The description may be provided in response to the request.

### BACKGROUND

Images of various scenes are captured at locations throughout the world at various times. Each captured image may contain a snapshot of event, place of interest, scenery, etc. present at the time the respective image was captured. Various systems which maintain these captured images as collections may require at least some manual input to catalog and organize the images. In some examples, the captured images may be processed using, for example, feature recognition tools in order to identify the features and scenes within the images. Some systems provide for automatic labeling of images.

### SUMMARY

Embodiments within the disclosure relate generally to area modeling by geographic photo label analysis. One aspect includes a method for determining a description of a geographic area. A set of images, wherein each image in the set of images includes data associated with a geolocation at which the image was captured and one or more labels describing the contents of the image may be received by one or more processing devices. The one or more processing devices may then assign each image in the set of images to one or more buckets corresponding to a geographic area based at least in part on the geolocation information of the image; receive an inquiry identifying one or more geolocations; determine a set of the one or more buckets that are associated with geographic areas that cover the one or more geolocations; identify labels associated with the images assigned to the set of buckets; generate a description of the one or more geolocations, based on the identified labels; and provide the description in response to the request.

Another embodiment provides a system for determining a description of a geographic area. The system may include one or more computing devices having one or more processors; and memory storing instructions, the instructions executable by the one or more processors. The instructions may include receiving a set of images, wherein each image in the set of images includes data associated with a geolocation at which the image was captured and one or more labels describing the contents of the image; assigning each image in the set of images to one or more buckets corresponding to a geographic area based at least in part on the geolocation information of the image; receiving an inquiry identifying one or more geolocations; determining a set of the one or more buckets that are associated with geographic areas that cover the one or more geolocations; identifying labels associated with the images assigned to the set of buckets; generating a description of the one or more geolocations, based on the identified labels; and providing the description in response to the request.

Another embodiment provides a non-transitory computer-readable medium storing instructions. The instructions, when executed by one or more processors, cause the one or more processors to: receive a set of images, wherein each image in the set of images includes data associated with a geolocation at which the image was captured and one or more labels describing the contents of the image; assign each image in the set of images to one or more buckets corresponding to a geographic area based at least in part on the geolocation information of the image; receive an inquiry identifying one or more geolocations; determine a set of the one or more buckets that are associated with geographic areas that cover the one or more geolocations; identify labels associated with the images assigned to the set of buckets; generate a description of the one or more geolocations, based on the identified labels; and provide the description in response to the request.

### BRIEF DESCRIPTION OF THE DRAWINGS

FIG. 1 is a functional diagram of an example system in accordance with aspects of the disclosure.

FIG. 2 is a pictorial diagram of the example system of FIG. 1.

FIG. 3 is an example of geolocations where images are captured in accordance with aspects of the disclosure.

FIG. 4 is an example of automatic image labeling in accordance with aspects of the disclosure.

FIG. 5 is an example of a database for storing images in association with other data in accordance with aspects of the disclosure.

FIG. 6A is an example of binning images in accordance with aspects of the disclosure.

FIG. 6B is an example of geographic bins in accordance with aspects of the disclosure.

FIG. 7 is an example of automatic image labeling in accordance with aspects of the disclosure.

FIG. 8 is an example of automatic image labeling for a in accordance with aspects of the disclosure.

FIG. 9 is an example of automatic image labeling in accordance with aspects of the disclosure.

FIG. 10 is a flow diagram in accordance with aspects of the disclosure.

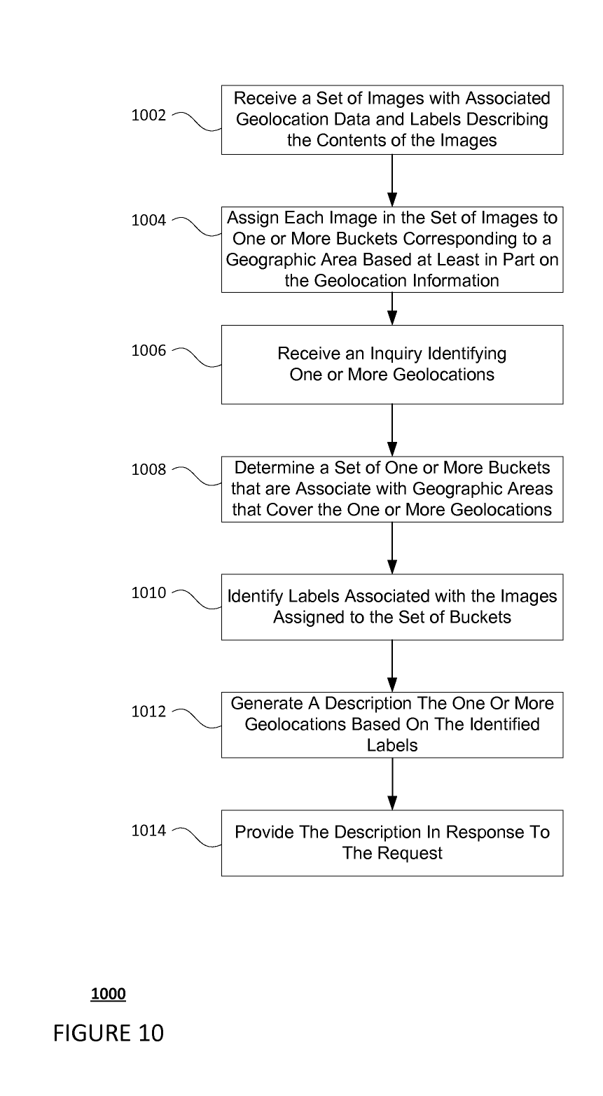

### DETAILED DESCRIPTION

### Overview

The technology relates to area modeling by geographic photo label analysis. For example, every image from a collection of images may automatically be assigned one or more labels which describe the scene captured in the image. Additionally, each image from the collection of images may be associated with a geolocation where the respective image was taken, as well as with the time and date the respective image was taken. Each image from the collection of images may also be organized into space-time buckets according to their associated geolocation, time, and date information. Labels associated with images organized within one or more space-time buckets may then be used to provide users with descriptions of geographic areas at specific dates and/or times. Further, interests of a user can be determined based on a comparison of a user's location data, including paths taken by the user at specific times, to labels contained in images located along the user's path taken at or near the specific times.

In order to model an area with geographic photo label analysis, a collection of images may be gathered. In this regard, images from public or private sources may be gathered. For example, a web crawler may continually crawl through internet websites, and store every image that is found into a public cache or database. Further, images uploaded by a user onto a private social media website may be gathered for analysis but not made public. In some embodiments explicit permission to gather the uploaded images may be requested from the user. The gathered images may be of scenes captured indoors and/or outdoors.

Each image in the collection of images may then be assigned a label which indicates the contents of the scene captured in the respective image. In this regard, automatic photo label technology may attach labels to each image. In one example, a machine learning model may be trained on manually labeled images relative to a reference taxonomy. The trained machine learning model may then automatically assign labels to images in accordance with the reference taxonomy. For example, labels may include “fruit” for a picture of an apple, “car” for a picture which includes cars, a “park” for pictures of swings.

Each image in the collection of images may also be associated with location and time information. In this regard, each image may contain explicit location information stored directly in the metadata stored in association with each web-based image. For example, an image may include an explicit longitude and latitude reading in the captured image's metadata, such as the EXIF information.

Alternatively, or in addition to the explicit location information, implicit location information may be derived from determining the location of objects captured in each of the images. For example, a web-based image may have captured the Statue of Liberty. The location of the Statue of Liberty may be known, and an estimation of the location of where the web-based image was captured can be made based on the known location. In this regard, the estimation of the location can be refined based on the image data, such as the direction from which the image was captured. In another embodiment implicit web-based image location data may be inferred from the website which the web-based image was found. For example, a website which hosts a web-based image may include an address. The address on the website may then be associated with the web-based image hosted on the website.

Each image in the collection of images may be associated with a timestamp, including both a date and a time. Timestamp data may be found in the images metadata, such as the image's EXIF information. Each image may also be stored in a storage system in association with its respective location, labels, and time information.

The collection of images may be binned into geographic buckets. In this regard, each image from the collection of images may be placed into a geographic bucket, representing a certain geographical area. Each image from the collection of images may be associated with the geographic bucket which includes the location information associated with the respective image.

Each geographic bucket may be subdivided into space-time buckets. In this regard, the images contained in a geographic bucket can be analyzed to determine if they include timestamps. Each image in a geographic bucket which includes a timestamp can be indexed within a space-time bucket based on the timestamp information. The space-time buckets may be re-aggregated in time in various ways, such as by day of the week, hour of the day, minute of the day, day of the year, etc. As such, each space-time bucket may be descriptive of the location and date/time the images within the space-time bucket were captured.

One or more space-time buckets and/or geographic buckets may be mined for labels commonly used in describing the geographic area. In this regard, one or more space-time buckets or geographic buckets, collectively referred to as “buckets,” may be mined to determine the labels associated with the images within the one or more of the buckets. For example, all of the geographic buckets may be mined to determine labels that are commonly used within the images in the geographic buckets. In another example, a few geographic buckets may be mined, based upon a user and/or computing device inquiry, to determine commonly used labels of the images in those few buckets. Similarly, space-time buckets for a geographic area may also be mined to determine commonly used labels of the images in those space-time buckets associated with the geographic area at a certain time, such as a holidays, day of the year, weekdays, and/or weekends, etc. Based on the determined commonly used labels, a description of the geographic area may be determined. The number of buckets mined may be dependent upon the number of images within each bucket.

Additionally, the mining of the one or more buckets may be restricted based on privacy settings. In this regard, the images within the one or more of the buckets may be restricted based on image privacy levels. For example, images may be made private, semi-private, and/or public. In the case of private images, each individual user may need explicit permission from the owner of the respective private images, to mine the private images and/or to share any results of mining the private images, whereas semi-private images may allow certain groups of individuals to mine the semi-private images and/or to share the results of mining the semi-private images. Public images may allow for unrestricted access by all users.

Buckets may be mined based on importance criteria. In this regard, places or times which have great user interest may be mined automatically. For example, a new restaurant may have great interest to many users, and accordingly, all images taken at a location of the new restaurant may be categorized as high importance. As such, any image taken in the location of the new restaurant may automatically be mined to determine if the images contain a label associated with the new restaurant.

The determined labels may be used to provide a description of a location in a space and/or space-time, with no human input required. In this regard, based on the mined labels found within the inquired buckets, descriptions of the location covered by the inquired buckets may include details on the scenery, points of interest (POI) found in the location, and activities which occur at the location, amongst other possible details. Such information may be used to update mapping data, provide travel information, track businesses, etc. Accordingly, whole geographies, such as municipalities, states, or countries can be classified according to the photo labels the buckets which cover such an area contain, and their prominence relative to their occurrence in a “larger” sample. For instance, a municipality may have a statistically significant over-representation of the descriptive labels “football” and “rock climbing,” in comparison to an entire state.

The clustering of labels may provide more accurate description of the geographic area. In this regard, labels which are related, such as by a certain theme or category, may be clustered together, to avoid an over-representation. For example, labels such as “Fruit,” “Vegetables,” and “Market” may be clustered together. In another example, a town which hosts an annual flower festival may attract many visitors who capture images of various types of flowers, all of which are labeled. Further, the town may also have a famous church where the town's people spend their time, but is seldom photographed. Mining the labels of the images of the town, the flower festival may drastically overshadow the church, thereby providing an inaccurate description of the town. By clustering the flower labeled images together, the church label may become more representative of the town. Additionally, the images may be conditioned by time, to show that the flower festival is a single weekend event, thereby reducing the ranking the flower label has on describing the town.

Additionally, labels may also be used to show changes in points of interest over a period of time. In this regard, when a label set at a location changes in a statistically significant way over time, this can indicate many things, such as a time-bounded event has taken place, a business has opened or closed, and/or the region has changed in popularity for other reasons, etc.

The features described herein may all for modelling a geographical area through the use of images. By doing so, a computing device may update mapping data, provide travel information, track business locations, etc. The features may also be used to show changes in the location of points of interest, such as businesses, over a period of time. In addition, by binning images into geographic buckets and space-time buckets, processing power and time may be saved, as potentially billions of images may be removed from an inquiry of the labels associated with the images.

### Example Systems

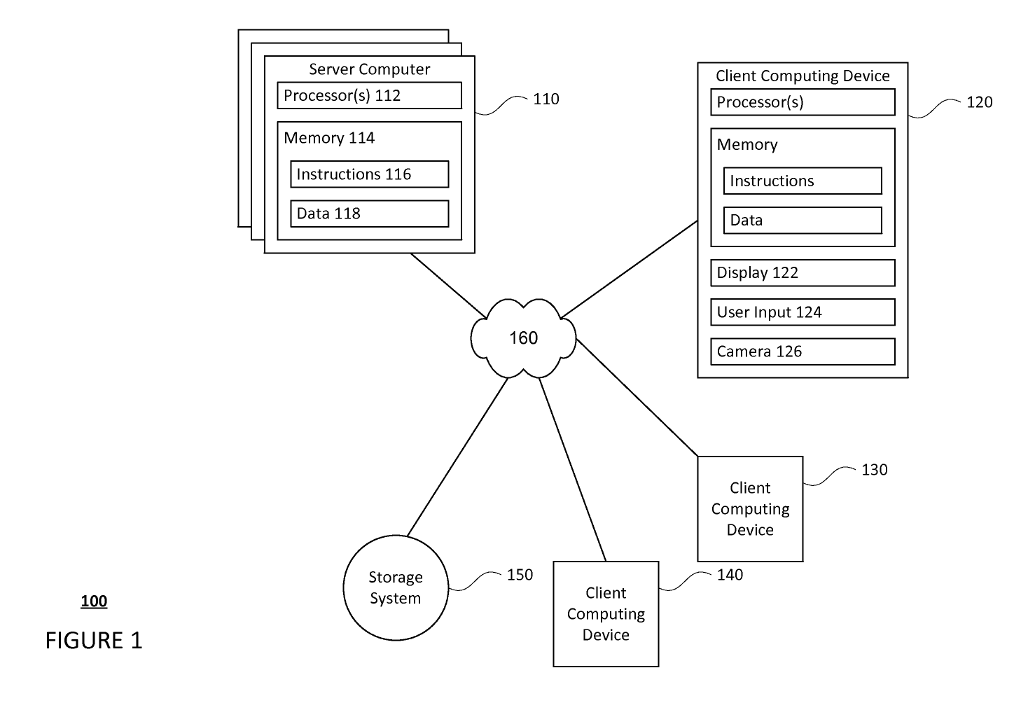

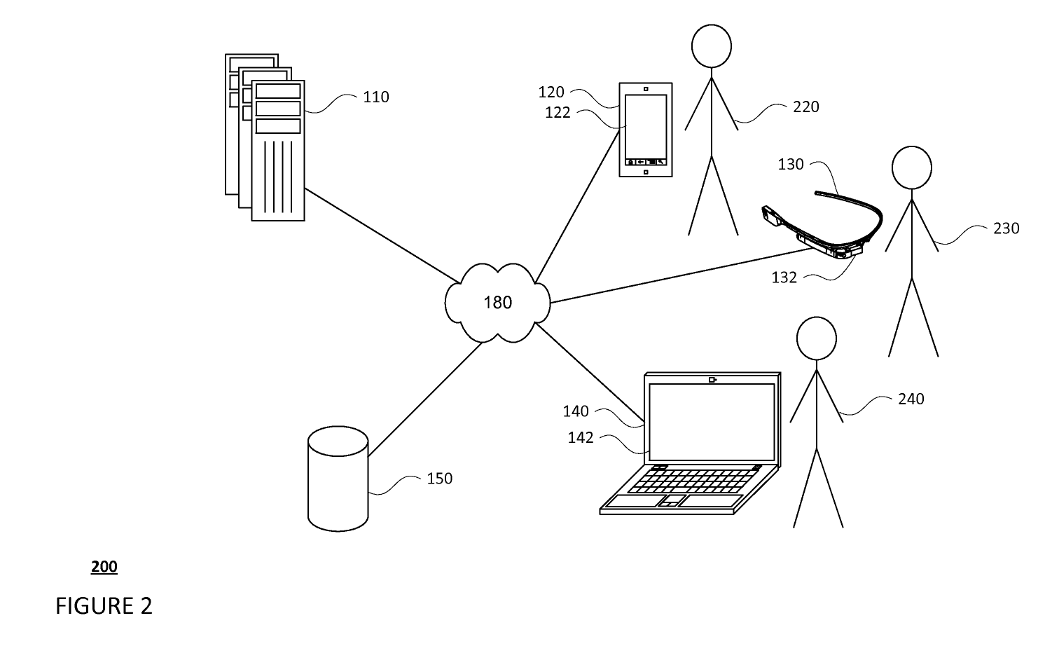

FIGS. 1 and 2 include an example system 100 in which the features described above may be implemented. It should not be considered as limiting the scope of the disclosure or usefulness of the features described herein. In this example, system 100 can include computing devices 110, 120, 130, and 140 as well as storage system 150. Each computing device 110 can contain one or more processors 112, memory 114 and other components typically present in general purpose computing devices. Memory 114 of each of computing devices 110, 120, 130, and 140 can store information accessible by the one or more processors 112, including instructions 116 that can be executed by the one or more processors 112.

Memory can also include data 118 that can be retrieved, manipulated or stored by the processor. The memory can be of any non-transitory type capable of storing information accessible by the processor, such as a hard-drive, memory card, ROM, RAM, DVD, CD-ROM, write-capable, and read-only memories.

The instructions 116 can be any set of instructions to be executed directly, such as machine code, or indirectly, such as scripts, by the one or more processors. In that regard, the terms “instructions,” “application,” “steps,” and “programs” can be used interchangeably herein. The instructions can be stored in object code format for direct processing by a processor, or in any other computing device language including scripts or collections of independent source code modules that are interpreted on demand or compiled in advance. Functions, methods, and routines of the instructions are explained in more detail below.

Data 118 may be retrieved, stored or modified by the one or more processors 112 in accordance with the instructions 116. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, ASCII or Unicode. Moreover, the data can comprise any information sufficient to identify the relevant information, such as numbers, descriptive text, proprietary codes, pointers, references to data stored in other memories such as at other network locations, or information that is used by a function to calculate the relevant data.

The one or more processors 112 can be any conventional processors, such as a commercially available CPU. Alternatively, the processors can be dedicated components such as an application specific integrated circuit (“ASIC”) or other hardware-based processor. Although not necessary, one or more of computing devices 110 may include specialized hardware components to perform specific computing processes, such as decoding video, matching video frames with images, distorting videos, encoding distorted videos, etc. faster or more efficiently.

Although FIG. 1 functionally illustrates the processor, memory, and other elements of computing device 110 as being within the same block, the processor, computer, computing device, or memory can actually comprise multiple processors, computers, computing devices, or memories that may or may not be stored within the same physical housing. For example, the memory can be a hard drive or other storage media located in housings different from that of the computing devices 110. Accordingly, references to a processor, computer, computing device, or memory will be understood to include references to a collection of processors, computers, computing devices, or memories that may or may not operate in parallel. For example, the computing devices 110 may include server computing devices operating as a load-balanced server farm, distributed system, etc. Yet further, although some functions described below are indicated as taking place on a single computing device having a single processor, various aspects of the subject matter described herein can be implemented by a plurality of computing devices, for example, communicating information over network 160.

Each of the computing devices 110 can be at different nodes of a network 160 and capable of directly and indirectly communicating with other nodes of network 160. Although only a few computing devices are depicted in FIGS. 1-2, it should be appreciated that a typical system can include a large number of connected computing devices, with each different computing device being at a different node of the network 160. The network 160 and intervening nodes described herein can be interconnected using various protocols and systems, such that the network can be part of the Internet, World Wide Web, specific intranets, wide area networks, or local networks. The network can utilize standard communications protocols, such as Ethernet, Wi-Fi and HTTP, protocols that are proprietary to one or more companies, and various combinations of the foregoing. Although certain advantages are obtained when information is transmitted or received as noted above, other aspects of the subject matter described herein are not limited to any particular manner of transmission of information.

As an example, each of the computing devices 110 may include web servers capable of communicating with storage system 150 as well as computing devices 120, 130, and 140 via the network. For example, one or more of server computing devices 110 may use network 160 to transmit and present information to a user, such as user 220, 230, or 240, on a display, such as displays 122, 132, or 142 of computing devices 120, 130, or 140. In this regard, computing devices 120, 130, and 140 may be considered client computing devices and may perform all or some of the features described herein.

Each of the client computing devices 120, 130, and 140 may be configured similarly to the server computing devices 110, with one or more processors, memory and instructions as described above. Each client computing device 120, 130, or 140 may be a personal computing device intended for use by a user 220, 230, 240, and have all of the components normally used in connection with a personal computing device such as a central processing unit (CPU), memory (e.g., RAM and internal hard drives) storing data and instructions, a display such as displays 122, 132, or 142 (e.g., a monitor having a screen, a touch-screen, a projector, a television, or other device that is operable to display information), and user input device 124 (e.g., a mouse, keyboard, touch-screen, or microphone). The client computing device may also include a camera for recording video streams and/or capturing images, speakers, a network interface device, and all of the components used for connecting these elements to one another.

Although the client computing devices 120, 130, and 140 may each comprise a full-sized personal computing device, they may alternatively comprise mobile computing devices capable of wirelessly exchanging data with a server over a network such as the Internet. By way of example only, client computing device 120 may be a mobile phone or a device such as a wireless-enabled PDA, a tablet PC, or a netbook that is capable of obtaining information via the Internet. In another example, client computing device 130 may be a head-mounted computing system. As an example the user may input information using a small keyboard, a keypad, microphone, using visual signals with a camera, or a touch screen.

As with memory 114, storage system 150 can be of any type of computerized storage capable of storing information accessible by the server computing devices 110, such as a hard-drive, memory card, ROM, RAM, DVD, CD-ROM, write-capable, and read-only memories. In addition, storage system 150 may include a distributed storage system where data is stored on a plurality of different storage devices which may be physically located at the same or different geographic locations. Storage system 150 may be connected to the computing devices via the network 160 as shown in FIG. 1 and/or may be directly connected to any of the computing devices 110, 120, 130, and 140 (not shown).

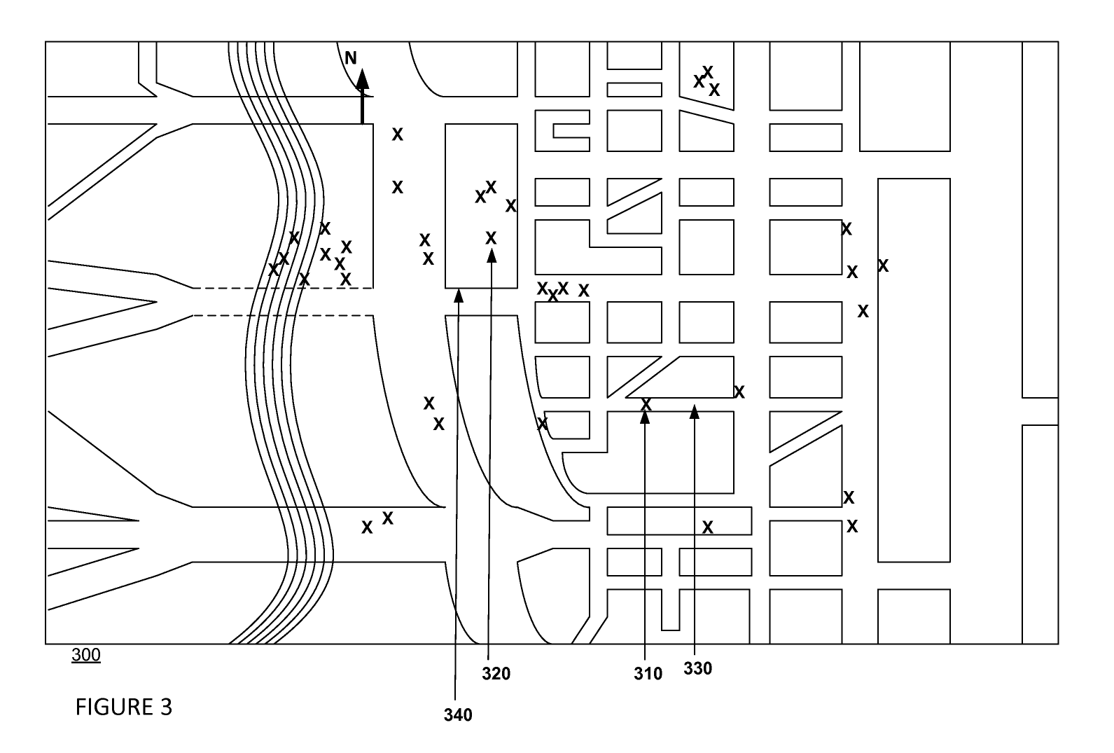

Storage system 150 may store a collection of images. At least some of the images of the collection of images may include scenes captured indoors and/or outdoors. As shown in FIG. 3, locations of a collection of images are overlaid on a map 300, of a downtown portion of a city. Each ‘X’ may indicate a location where an image of the collection of images was captured. In this regard image 310 is shown as captured outside, in street 330, while image 320 is shown as captured indoors, in building 340.

Each image in the collection of images may be assigned a label which indicates the contents of the scene captured in the respective image. In this regard, automatic photo label technology, implemented by one or more processors, such as processors 112 of one or more server computing devices 110, may attach labels to each image. In one example, techniques which analyze contents within a photo, to assign an annotation describing the contents to the photo, such as found in the Automatic Linguistic Indexing of Pictures (ALIPR) algorithm, may be used to automatically label photos. In some embodiments, a machine learning model may be trained on manually labeled images relative to a reference taxonomy. The trained machine learning model may then automatically assign labels to images in accordance with the reference taxonomy.

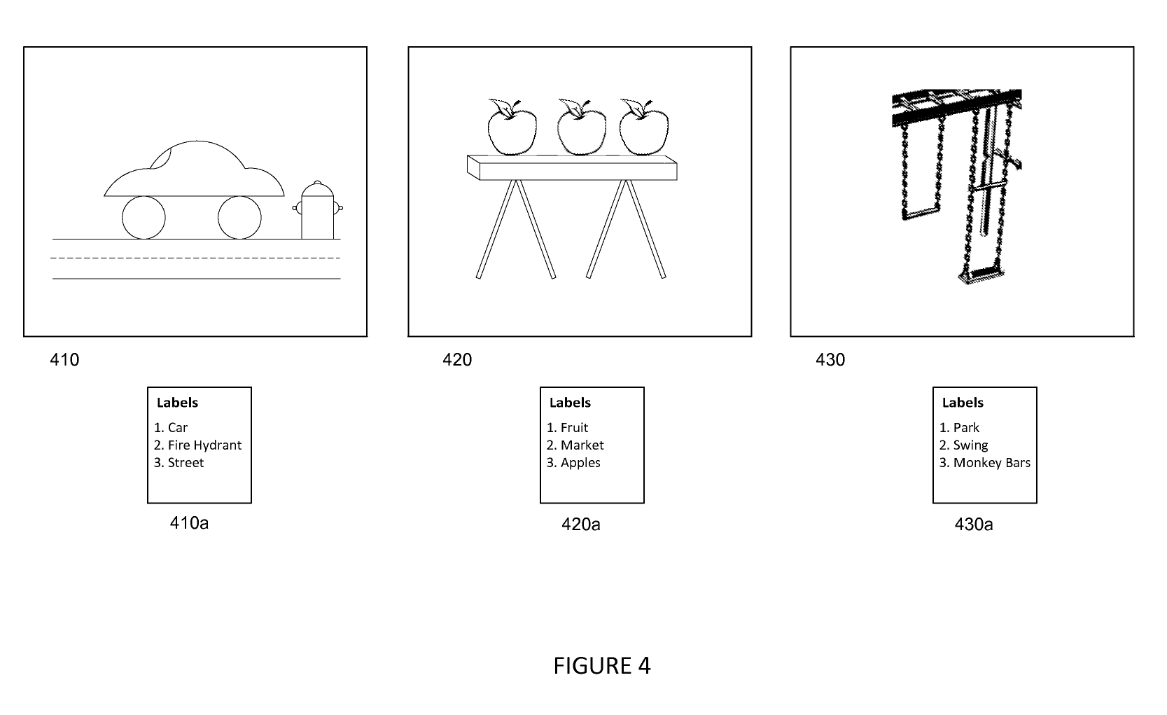

FIG. 4 is examples of labels which the automatic photo label technology may assign to images in the collection of images. In this regard, image 410 includes a scene of a parked car on a street next to a fire hydrant. Accordingly, the automatic photo label technology may analyze image 410 and assign the labels “car,” “fire hydrant,” and “street,” as shown in table 410a. Image 420 includes a scene of an apple stand at a farmers market, and may be labeled by the automatic photo label technology with the labels “fruit,” “market,” and “apples” as shown in table 420a. Image 430 includes a scene of swings and monkey bars at a park. As such, the automatic photo label technology may assign image 430 the labels of “park,” “swing,” and “monkey bars,” as shown in table 430a.

Each image in the collection of images may also be associated with a location, such as an address or geolocation. In this regard, each image may contain either implicit or explicit location information. For example, an image in the collection of images may include an explicit longitude and latitude reading in the captured image's metadata, such as the EXIF information. EXIF data may provide the location an image in the collection of images was captured. In another embodiment location information an image in the collection of images image location data may be inferred from a website at which the image was or can be found.

Alternatively, or in addition to the explicit location information, implicit location information may be derived from determining the location of objects captured in each of the images in the collection of images. For example, an image in the collection of images may have captured the Statue of Liberty. The location of the Statue of Liberty may be known, and an estimation of the location of where the image was captured can be made based on the known location. In this regard, the estimation of the location can be refined based on the image data, such as the direction from which the image was captured. In another embodiment implicit web-based image location data may be inferred from the website which the web-based image was found. For example, a website which hosts a web-based image may include an address. The address on the website may then be associated with the web-based image hosted on the website.

Additionally, each image may be associated with time information, such as a timestamp, which may include a date and/or a time. Timestamp data may be found in the images metadata, such as the images EXIF information, and/or entered manually by a user, such as user 220, 230, or 240.

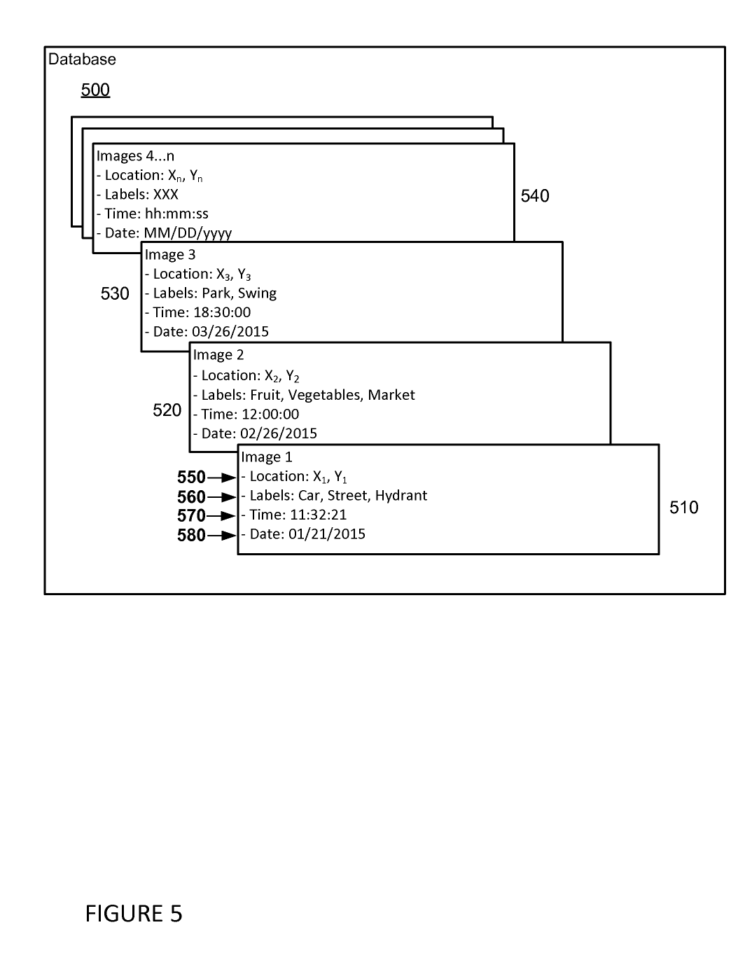

Each image in the collection of images may also be stored in storage system 150 in association with its respective location, labels, and time information, as shown in FIG. 5. In this regard, database 500 may store any number of images including image 1 510, image 2, 520, and image 3 530. Additional images 4-n 540 may also be stored in database 500. Each image may be stored in association with image data, location data, labels, and/or time and date data. For example, image 1 510, may be stored in association with explicit location information 550 indicating that image 1 was captured at location of X1, Y1. Additionally, database 500 may store image 1 510 in association with its respective timestamp. In this regard, image 1 510 may include both time 570 and date 580 information indicating image 1 510 was captured at 11:32:21 on Jan. 21, 2015. Additionally, image 1 510 may be stored in association with labels 560 which may be assigned to image 1 510 by the automatic photo label technology.

### Example Methods

In order to model an area with geographic photo label analysis, a collection of images may be gathered. In this regard, images from public or private sources may be gathered, and in some cases, stored in storage system 150. For example, a web crawler may continually crawl through internet websites, and store every image that is found. Further, images uploaded by a user, such as one or more of users 220, 230, or 240, onto a private social media website may be gathered with permission, but not made public. The collection of images may then be stored as discussed above in the storage system 150.

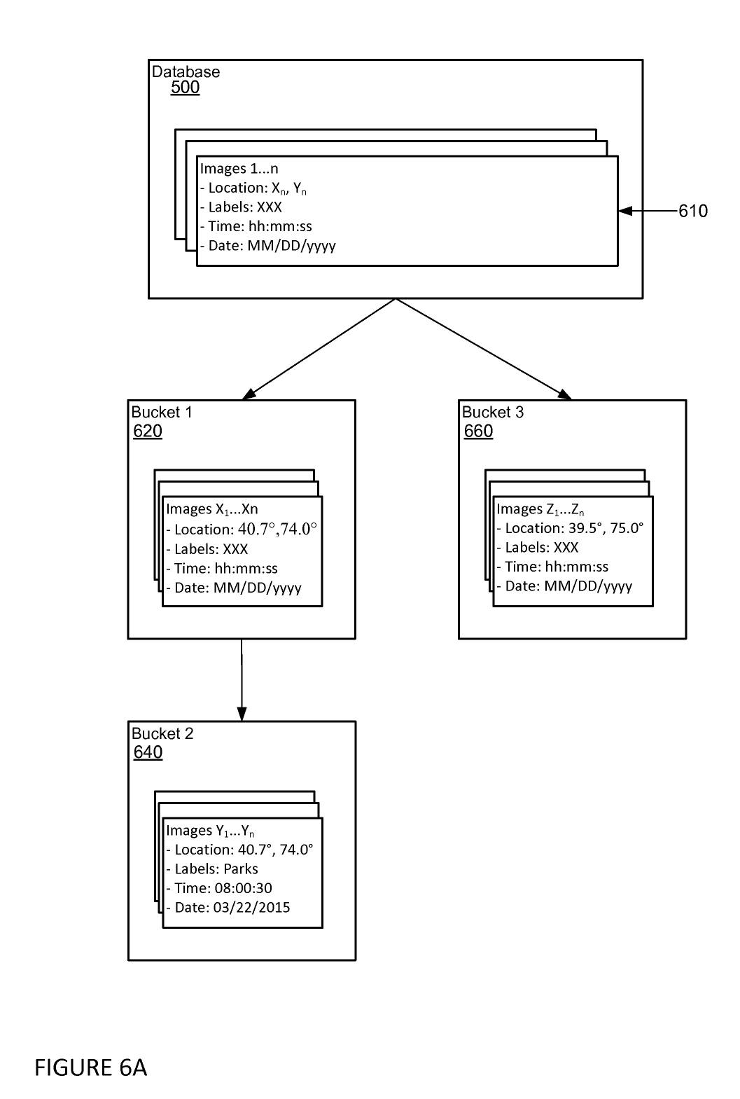

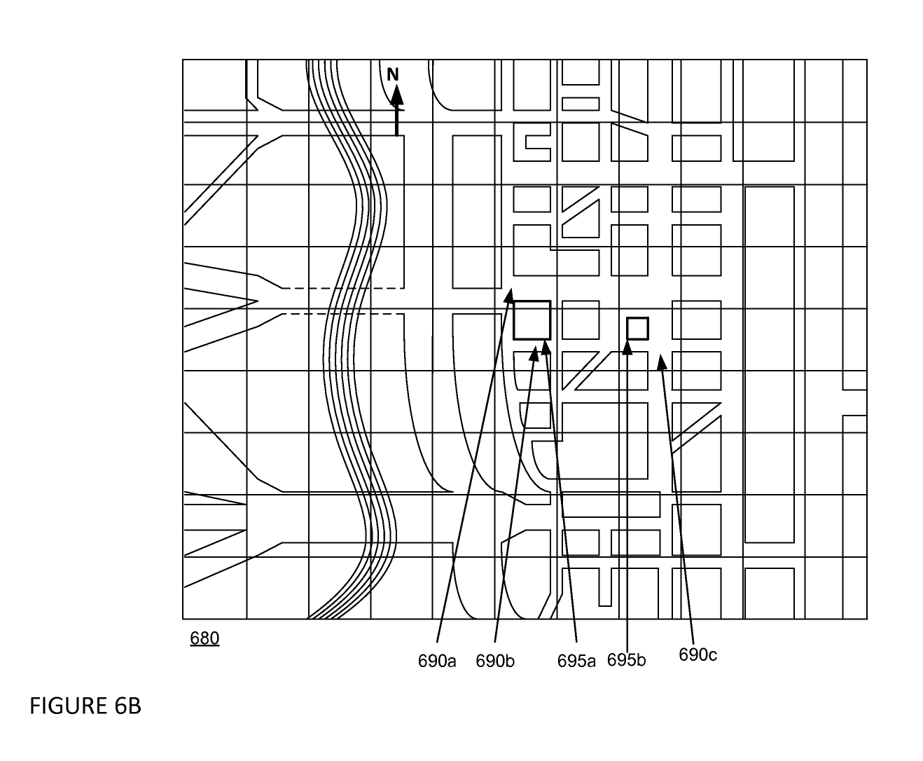

The collection of images may be binned into geographic buckets. In this regard, each image from the collection of images may be placed into a geographic bucket, representing a certain geographical area, as shown in FIG. 6A. Database 500 may store the collection of images 610, in association with the location, labels, and/or timestamp data of each respective image. Each image from the collection of images 610 may be associated with a geographic bucket which matches and/or includes the location information associated with the respective image. The geographic buckets may cover areas such as countries, states, cities, city blocks, zip codes, a predetermined amount of square miles/feet, etc. For example, as shown in FIG. 6A, the collection of images 610 may be subdivided into geographic buckets 620 and 660. In this regard, each image of the collection of images 610 which was captured at, or within the geographic bucket which includes location 40.7°, 74.0° may be binned into geographic bucket 1 620. Additionally, each image of the collection of images 610 which was captured at, or within the geographic bucket which includes location 39.5°, 75.0° may be binned into geographic bucket 3 660.

Each geographic bucket may cover the same amount of geographic area (for example, the same number of square miles or meters), or may be of different sizes or areas. For example, a geographic bucket may cover an area of thirty square meters, or more or less. Depending on the size of the geographic buckets, landmarks such as buildings, parks, waterways, highways, etc. may be present in one or more geographic buckets. FIG. 6B illustrates a geographic area 680 which has been divided into geographic buckets, including geographic buckets 690a-690c. As shown in FIG. 6B, building 695a, captured in an image from the collection of images, is present in two geographic buckets 690a and 690b, whereas building 695b, also captured in an image from the collection of images, is present only in one geographic bucket 690.

In some examples, the geographic buckets may be subdivided into space-time buckets. In this regard, the images contained in a geographic bucket can be analyzed to determine if they include timestamps. Each image in a geographic bucket which includes a timestamp can be indexed within a space-time bucket of the geographic bucket based on the timestamp information. The space-time buckets may be re-aggregated in time in various ways, such as by day of the week, hour of the day, minute of the day, day of the year, etc. As such, each space-time bucket may be descriptive of the location and date/time the images within the space-time bucket were captured. Referring back to FIG. 6A, each image in the collection of images assigned to geographic bucket 1, which were captured on and/or around 08:00:30, on and/or around March 22, 2015, may be placed into a single space-time bucket 640. As such, each image in space-time bucket 2 640 may be associated with both geographic bucket 1 and space-time bucket 2 640.

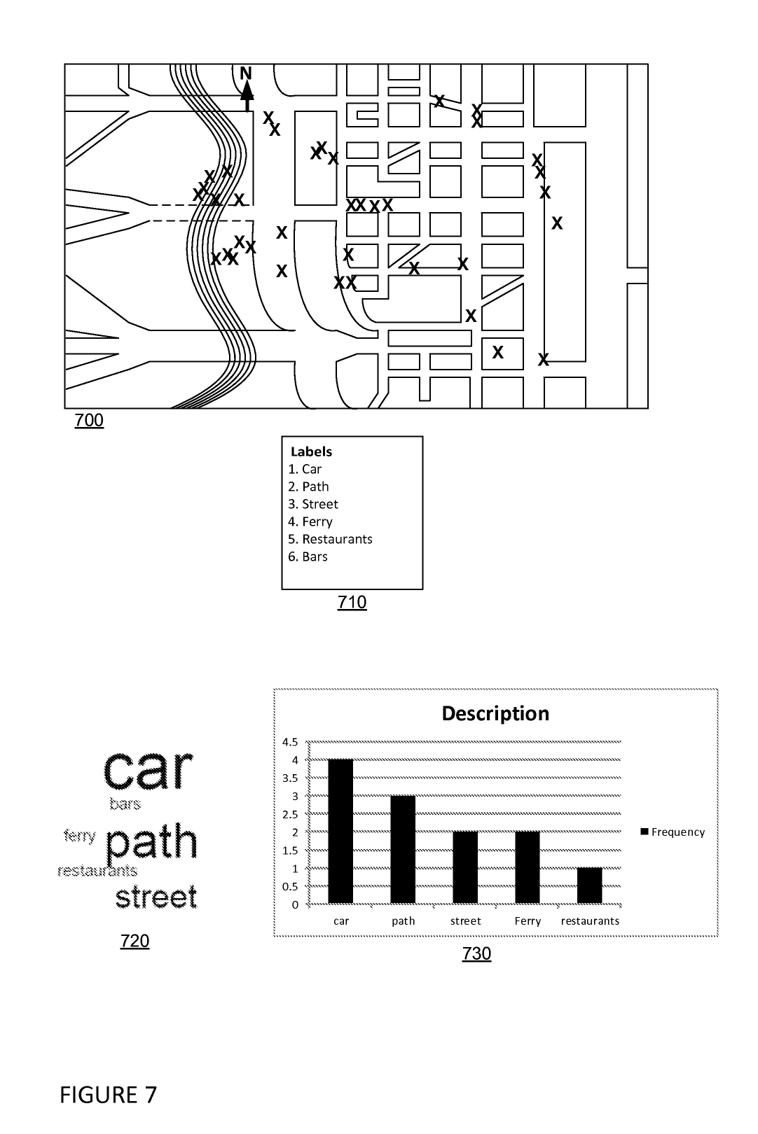

One or more space-time buckets and/or geographic buckets may be mined for labels which are descriptive of the buckets covering the geographic area. In this regard, one or more space-time buckets or geographic buckets, collectively referred to as the “buckets,” may be mined to determine the labels associated with the images within the one or more of the buckets. FIG. 7 illustrates locations of a collection of images overlaid on a map 700, of a downtown area of a city. Each ‘X’ may indicate a location where images of the collection of images assigned to one or more buckets covering the downtown area of the city were captured. The buckets covering the downtown area of the city may be mined, and labels associated with the images in a geographic bucket covering the downtown area may be determined. The resulting determined labels of the downtown portion of the city, may include “car,” “path,” and “street” as shown in table 710.

Based on the determined labels, a description of the downtown area corresponding to or within the mined one or more buckets may be generated. For example, a description of the downtown area of a city may be determined by selecting the determined labels which are most common, as descriptive of the downtown area. In this regard, the most common labels which are descriptive of the downtown area of the city, may include “car,” “path,” and “street” as shown in table 710. Accordingly, the labels “car,” “path,” and “street” may be used in various combinations to generate a textual or graphical description for the downtown area of the city, such as “Downtown with cars and path trains.” In some embodiments, graphical descriptions for the downtown area of the city may include histograms representing the frequency which the most common labels are used, as shown in 720, word clouds representing the frequency which the most common labels are used, as shown in 730, and/or image clouds. Similar to word clouds, image clouds may include images which are sized to show their relative prominence in the most common labels. Such images may be exemplars of a category of the most common labels, or even categorical icons (e.g., cars, people, food, houses, outdoor recreation, playground, etc.).

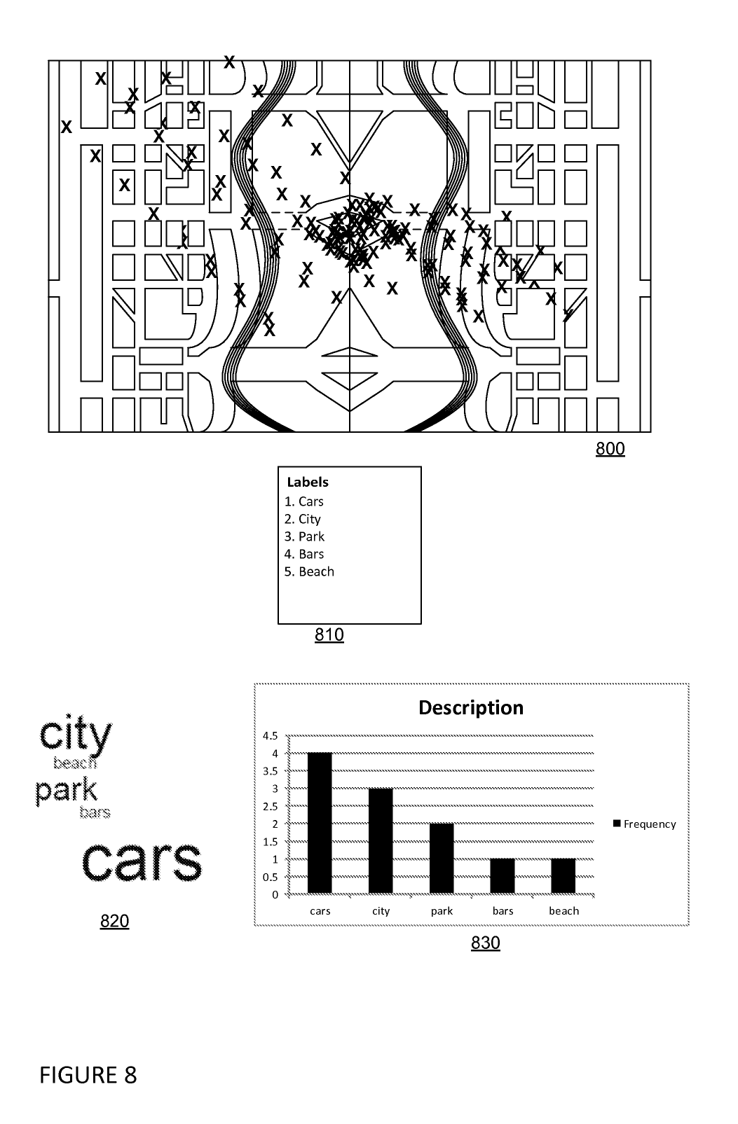

FIG. 8 illustrates locations of a collection of images overlaid on a map 800, of an entire city. Each ‘X’ may indicate a location where images of the collection of images assigned to one or more buckets covering the entire city were captured. The buckets covering the entire city area may be mined, and labels associated with the images in a geographic bucket covering the entire city area may be determined. The resulting determined labels of the entire city area, may include “cars,” “city,” and “park” as shown in table 810. In this regard, the resulting labels of the entire city area, as shown in table 810, may be different than the resulting labels of the downtown area 700, as shown in table 710 of FIG. 7.

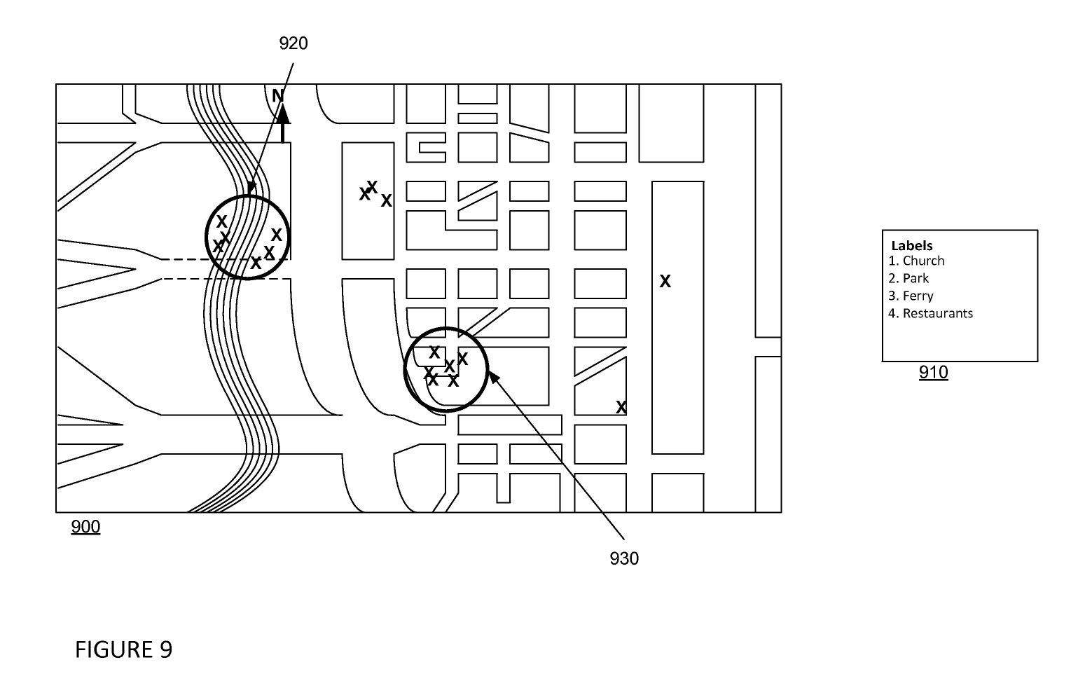

Based on the determined labels, a description of entire city area, corresponding to or within the mined bucket or buckets may be generated. For example, a description for an entire city may be determined by selecting the determined labels which are most common, as descriptive of the entire city area. Accordingly, the labels “cars” “city” “park” may be used in various combinations to generate a description for the entire city area, such as “City with cars and parks.” In some embodiments, graphical descriptions for the entire city area may include histograms representing the frequency which the most common labels are used, as shown in 820, and/or word clouds representing the frequency which the most common labels are used, as shown in 830, and/or image clouds. Similar to word clouds, image clouds may include images which are sized to show their relative prominence in the most common labels. Such images may be exemplars of a category of the most common labels, or even categorical icons (e.g., cars, people, food, houses, outdoor recreation, playground, etc.). Similarly, specific space-time buckets for a geographic area may also be mined to determine the labels of the images in those buckets associated with the geographic area at a certain time. For example, images binned in geographic buckets covering a downtown area, may be subdivided into at least one space-time bucket associated with all images taken on Sundays, as shown in FIG. 9. FIG. 9 illustrates locations of a collection of images overlaid on a map 900, of a downtown area of a city. Each ‘X’ may indicate a location where images of the collection of images assigned to the at least one space-time bucket covering the entire downtown area, taken on a Sunday, were captured. As can be seen in the map 900 clusters of images by a park 920 and clusters of images by a church 930 may be present in the at least one space-time bucket. The buckets covering the at least one space-time bucket covering the entire downtown area, taken on a Sunday, may be mined, and labels associated with the images in the at least one space-time bucket may be determined. The resulting determined labels of entire downtown area, taken on a Sunday may include “church,” “park,” and “ferry” as shown in table 910.

Based on the determined labels a description of the entire downtown area of the city, during Sundays, may be generated. For example, a description of the entire downtown area of the city, during Sundays, may be determined by selecting the common labels as descriptive of the downtown area of the city during Sundays. Accordingly, the labels “church” and “park”, as shown in table 910, may be used in various combinations to generate a textual or graphical description for the downtown area of the city during Sundays.

Buckets may be mined based on an inquiry received by one or more computing devices, such as computing devices 110, 120, 130, and 140. In this regard, inquiries may be made by a user or a computing device. For example, a user, such as user 120, may make an inquiry for the description of a block in a city. In response, a determination may be made to determine which buckets cover the block in the city. The determined buckets may then be mined for labels, which may be descriptive of the block in the city. In other embodiments an inquiry may include a request for the description of a block in a city at a certain time period. The number of buckets mined to determine labels may be dependent upon the number of images within each bucket. For example, when mined labels are developed from a small group of images, such as 250 or more or less, unreliable result descriptions for the geographic area may be output. Further, the descriptions of images which are contained in multiple buckets, such as two or more buckets, may be included only once, so as to avoid over-representing the descriptions in the images.

Additionally, the mining of the one or more buckets may be restricted based on privacy settings. In this regard, the images within the one or more of the buckets may be restricted based on image privacy levels. For example, images may be made private, semi-private, and/or public. In the case of private images, each individual user may need permission to mine the private images, whereas semi-private images may allow certain groups of individuals to mine the semi-private images. Public images may allow for unrestricted access by all users.

Buckets may also be mined based on importance criteria. In this regard, places or times which have great user interest, determined by the frequency of images being captured at that location, may be mined automatically. For example, a new restaurant may have great interest to many users, and accordingly, an uptick of images may be captured at the location of the new restaurant. Upon determining that the uptick of images, the buckets covering the location of the new restaurant may be categorized as high importance. As such, the buckets covering the location of the restaurant may be automatically mined to determine if the images contain a label associated with the new restaurant.

The determined labels may be used to provide a description of a location in a space and/or space-time, without the need for human input. In this regard, based on determined labels mined from buckets covering a location and/or location at a specific time, descriptions of the location covered by the buckets may automatically be determined. Such descriptions may include details on the scenery, points of interest (POI) found in the location, and activities which occur at the location, amongst other possible details. Such information may be used to update mapping data, provide travel information, track businesses, etc. Accordingly, whole geographies, such as municipalities, states, or countries can be classified according to the photo labels the buckets which cover such an area contain, and their prominence relative to their occurrence in a “larger” sample. For instance, a municipality may have a statistically significant over-representation of the descriptive labels “football” and “rock climbing,” in comparison to other municipalities across an entire state. Accordingly, the municipality may be classified using these comparatively over-represented labels whereas other municipalities with lower occurrences of such descriptive labels would not have such classifications.

The clustering of labels may provide more accurate description of the geographic area. In this regard, labels which are related, such as by a certain theme or category, may be clustered together, to avoid an over-representation of a single description. For example, labels such as “Fruit” “Vegetables” may be clustered together into a single description, such as “produce.” In another example, a town which hosts an annual flower festival may attract many visitors who capture images of various types of flowers, each of which is labeled with the respective names of the type of flower captured in the image. Further, the town may also have a famous church where the town's people spend their time, but is seldom photographed. Mining the labels of the images captured in geographic buckets of the town, labels associated with the flower festival may be more common than labels associated with the church. As such, upon determining the description of the town, the most common labels selected as descriptive of the town may all be from the flower festival. Accordingly, an inaccurate description of the town may result as the church is not shown as descriptive of the town. By clustering the flower labeled images together with a single label, such as “flowers,” the description of the town may change, as labels of the flower festival will be clustered under a single label. As such, the church label may become more representative of the town since it may be up towards the top labels determined as descriptive of the town.

Additionally, the images may be conditioned by time. For example, the flower festival may be a single weekend event, resulting in the images captured during the festival all having time stamps associated with the weekend of the flower festival. In order to prevent the over representation of the flower festival in the description of the town, the labels of the images associated with the time of the flower festival may be determined to be less descriptive of the town. Accordingly, the determination of the description of the town may have a reduced reliance on the labels associated with the images which captured the flower festival, thereby reducing the ranking the flower festival has on describing the town.

Additionally, labels may also be used to show changes in points of interest over a period of time. In this regard, when labels in buckets covering a location change in a statistically significant way over a period of time, this can indicate many things, such as a time-bounded event has taken place, a business has opened or closed, and/or the region has changed in popularity for other reasons, etc.

Analysis of labels may also be used to identify information about specific locations. By analyzing labels distributions through space and time, information about what types of events occur or features exist at a specific location and, in some cases, at a particular date and/or time, can be determined. This may work especially well for labels that have a high specificity in space and/or time, such as labels describing a time-bounded event (e.g. a weekly farmers market, a sporting event, etc.) or labels corresponding to a singular purpose (such as a restaurant or business).

Flow diagram 1000 of FIG. 1 is an example flow diagram of some of the aspects described above that may be performed by one or more computing devices, such as client computing devices 110-140. In this example, at block 1002 a set of images may be received, wherein each image includes data associated with geolocation data and labels describing the contents of the images. At block 1004, each image in the set of images may be assigned to one or more buckets corresponding to a geographic area based at least in part on the geolocation information. At block 1006, an inquiry identifying one or more geolocations may be received, and a set of one or more buckets that are associated with geographic areas that cover the one or more geolocations may be determined, as shown at block 1008. Labels associated with the images assigned to the set of buckets may be identified, as shown at block 1010, and a description of the one or more geolocations may be generated as shown at block 1012. At block 1014, the description may be provided in response to the request.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order, such as reversed, or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A computer implemented method for determining a description of a geographic area, the method comprising:
receiving, by one or more processing devices, a set of images, wherein each image in the set of images includes data associated with a geolocation at which the image was captured and one or more labels describing the contents of the image;
assigning, by the one or more processing devices, each image in the set of images to one or more buckets corresponding to a geographic area based at least in part on the geolocation information of the image;
receiving, by the one or more processing devices, an inquiry identifying one or more geolocations;
determining, by the one or more processing devices, a set of the one or more buckets that are associated with geographic areas that cover the one or more geolocations;
identifying, by the one or more processing devices, labels associated with the images assigned to the set of buckets;
generating, by the one or more processing devices, a description of the one or more geolocations, based on the identified labels; and
providing, by the one or more processing devices, the description in response to the request.

2. The method of claim 1, wherein each image in the set of images is associated with a timestamp indicating the date and time the image was captured, further comprising:
sub-dividing each of the one or more buckets into space-time buckets by assigning each image in the set of images to one or more space-time buckets based on the respective timestamp associated with the image.

3. The method of claim 2, wherein receiving an inquiry of one or more geolocations further comprises:
receiving an inquiry of a specific time period; and
determining the labels associated with the images assigned to the selected one or more space-time buckets covering the specific time period and one or more geolocations inquired.

4. The method of claim 1, further comprising:
prior to determining a description of the geographic areas associated with the selected one or more buckets, clustering related labels, wherein determining a description of the geographic areas associated with the selected one or more buckets is further based on the clustered labels.

5. The method of claim 1, further comprising using the description to provide a classification for the one or more geographic locations based on a comparison of a number of occurrences of one of the identified labels to a number of occurrences of the one of the identified labels in a bucket corresponding to another geographic location.

6. The method of claim 5, wherein providing the classification is further based on a number of occurrences of the one of the identified labels in a bucket corresponding to a plurality of geographic locations of a same type within a geographic region including the one or more geographic locations and the another geographic location.

7. The method of claim 1 further including:
updating, by the one or more processing devices, a location database by associating the labels associated with the images to the inquired area.

8. A system for determining a description of a geographic area, the system comprising:
one or more computing devices having one or more processors; and
memory storing instructions executable by the one or more processors, wherein the instructions comprise:
receiving, by one or more processing devices, a set of images, wherein each image in the set of images includes data associated with a geolocation at which the image was captured and one or more labels describing the contents of the image;
assigning, by the one or more processing devices, each image in the set of images to one or more buckets corresponding to a geographic area based at least in part on the geolocation information of the image;
receiving, by the one or more processing devices, an inquiry identifying one or more geolocations;
determining, by the one or more processing devices, a set of the one or more buckets that are associated with geographic areas that cover the one or more geolocations;
identifying, by the one or more processing devices, labels associated with the images assigned to the set of buckets;
generating, by the one or more processing devices, a description of the one or more geolocations, based on the identified labels; and
providing, by the one or more processing devices, the description in response to the request.

9. The system of claim 8, wherein each image in the set of images is associated with a timestamp indicating the date and time the image was captured, and wherein the instructions further include:
sub-dividing each of the one or more buckets into space-time buckets by assigning each image in the set of images to one or more space-time buckets based on the respective timestamp associated with the image.

10. The system of claim 9, wherein the instruction of determining the labels associated with the images assigned to the selected one or more buckets further includes:
receiving, by the one or more computing devices, an inquiry of a specific time period; and
determining the labels associated with the images assigned to the selected one or more space-time buckets covering the specific time period and one or more geolocations inquired.

11. The system of claim 8, wherein the instructions further include:
prior to determining a description of the geographic areas associated with the selected one or more buckets, clustering related labels, wherein determining a description of the geographic areas associated with the selected one or more buckets is further based on the clustered labels.

12. The system of claim 8, wherein the instructions further comprise the description to provide a classification for the one or more geographic locations based on a comparison of a number of occurrences of one of the identified labels to a number of occurrences of the one of the identified labels in a bucket corresponding to another geographic location.

13. The system of claim 12, wherein the instructions further comprise providing the classification is further based on a number of occurrences of the one of the identified labels in a bucket corresponding to a plurality of geographic locations of a same type within a geographic region including the one or more geographic locations and the another geographic location.

14. The system of claim 8, wherein the instructions further include:
updating a location database by associating the labels associated with the images to with the inquired area.

15. A non-transitory computer-readable medium storing instructions, which when executed by a processor, cause the processor to:
receive a set of images, wherein each image in the set of images includes data associated with a geolocation at which the image was captured and one or more labels describing the contents of the image;
assign each image in the set of images to one or more buckets corresponding to a geographic area based at least in part on the geolocation information of the image;
receive an inquiry identifying one or more geolocations;
determine a set of the one or more buckets that are associated with geographic areas that cover the one or more geolocations;
identify labels associated with the images assigned to the set of buckets;
generate a description of the one or more geolocations, based on the identified labels; and
provide the description in response to the request.

16. The non-transitory computer-readable medium of claim 15, wherein each image in the set of images is associated with a timestamp indicating the date and time the image was captured, and wherein the instructions further cause the processor to:
sub-divide each of the one or more buckets into space-time buckets by assigning each image in the set of images to one or more space-time buckets based on the respective timestamp associated with the image.

17. The non-transitory computer-readable medium of claim 16, wherein the instructions cause the processor to:
receive an inquiry of a specific time period; and
determining the labels associated with the images assigned to the selected one or more space-time buckets covering the specific time period and one or more geolocations inquired.

18. The non-transitory computer-readable medium of claim 15, wherein the instructions cause the processor to:
prior to determining a description of the geographic areas associated with the selected one or more buckets, cluster related labels, and
determine a description of the geographic areas associated with the selected one or more buckets is further based on the clustered labels.

19. The non-transitory computer-readable medium of claim 15, wherein the instructions further cause the processor to use the description to provide a classification for the one or more geographic locations based on a comparison of a number of occurrences of one of the identified labels to a number of occurrences of the one of the identified labels in a bucket corresponding to another geographic location.

20. The non-transitory computer-readable medium of claim 19, wherein the instructions further cause the processor to provide the classification further based on a number of occurrences of the one of the identified labels in a bucket corresponding to a plurality of geographic locations of a same type within a geographic region including the one or more geographic locations and the another geographic location.
